(19) United States
(12) Patent Application Publication
(10) Pub. No.: US 2021/0012421 A1
(43) Pub. Date: Jan. 14, 2021

(54) METHOD AND DEVICE FOR TRADING ON AN ELECTRONIC TRADING PLATFORM

(71) Applicant: Robert Bosch GmbH, Stuttgart (DE)

(72) Inventors: Denis Kramer, Schwieberdingen (DE); Fredrik Kamphuis, Leonberg (DE); Nik Scharmann, Bietigheim-Bissingen (DE)

(21) Appl. No.: 16/922,408

(22) Filed: Jul. 7, 2020

(30) Foreign Application Priority Data
Jul. 12, 2019 (EP) 19185983.4

(51) Int. Cl. G06Q 40/04; G06Q 20/38; G06Q 20/06; H04L 9/32

(52) U.S. Cl. CPC G06Q 40/04; G06Q 20/38215; H04L 2209/56; H04L 9/3221; G06Q 2220/00; G06Q 20/065

(57) ABSTRACT

A method for trading on an electronic trading platform. The method includes the following features: trade orders of subscribers of the trading platform are given, a decentralized transaction database of the trading platform is managed that includes an order book, balances of accounts of the subscribers, and a zero-knowledge proof of a present state of the transaction database. On the basis of trade orders of the subscribers, starting from the current state, the transaction database is brought into a new state by a multiparty calculation.

### CROSS REFERENCE

The present application claims the benefit under 35 U.S.C. § 119 of European Patent Application EP 19185983.4 filed on Jul. 12, 2019, which is expressly incorporated herein in its entirety.

### FIELD

The present invention relates to a method for trading on an electronic trading platform. In addition, the present invention relates to a corresponding device, a corresponding computer program, and a corresponding storage medium.

### BACKGROUND INFORMATION

Any protocol in computer networks that brings about a consensus with regard to the sequence of particular transactions, relating for example to the updating of data, is referred to as a decentralized transaction system or transaction database (distributed ledger). A frequent realization of such a system uses a block chain. In cryptology, this term is understood to refer to a database whose integrity is secured by storing a digital fingerprint (hash) of the preceding data record in the respectively following data record. Conventionally, this cryptographic chaining forms the basis of many cryptocurrencies, but can also contribute to increased transaction security in other types of distributed systems.

For example, German Patent Application No. DE 102017209014 A1 describes a method for joining transactions to a block chain in which subscribers of the computer network are determined who stand in a specified relationship, so-called multiplication triples (Beaver triples, Beaver's triples) are produced as a secret share among the subscribers, at least one multiplication triple among the multiplication triples is mapped to a hash value together with the transactions, and, if the hash value is below a specified target value, a block is transferred to the block chain that contains the multiplication triple mapped to the hash value as well as the transactions, and, using the remaining multiplication triples, a secure multiparty computation (MPC) is carried out in the computer network. Relevant protocols are described in BEAVER, Donald, “Efficient multiparty protocols using circuit randomization,” in: Annual International Cryptology Conference, Springer Berlin Heidelberg, 1991, pp. 420-432.

### SUMMARY

The present invention provides a method for trading on an electronic trading platform, a corresponding device, a corresponding computer program, and a corresponding storage medium.

The approach of the present invention is based on the recognition that modern marketplace platforms are operated by individual large companies. The resulting competitive limitations can result in high costs for the users of these platforms. Using game theory, it has for example been proven that it is in the interest of monopolistic platform operators to exploit their position at the cost of the market subscribers.

Because, from the point of view of the user, this type of market failure is undesirable, various possibilities have been proposed for decentralizing the operation of such a platform while maintaining the desired marketplace functionality. Using MPC, it is possible to implement such functions using a decentralized protocol between the subscribers without giving individual subscribers an exploitable advantage in knowledge or power. However, MPC protocols are very complex, especially when the number of users is large. Therefore, MPC trading platforms are standardly limited to implementing marketplace functionality for arbitrarily many parties according to a protocol that is followed only by some of these parties.

The present invention is in addition based on the insight that—similar to the decentralized creation of money in cryptocurrency systems, or so-called mining—for the parties of an MPC protocol it is worthwhile to accept the associated calculation expense only if there is an incentive to do so. While in decentralized transaction systems, rewards are paid for provided proofs of work, for MPC-based marketplace protocols no technical systems are currently known that offer an incentive to follow these protocols.

In addition, a transaction system according to the present invention takes into account the circumstance that for an MPC implementation of marketplaces it is essential that the protocol used for this purpose does not divulge any secrets, so that in some circumstances it is difficult to distinguish correct calculations from random values on the basis of individual protocol messages. In order to prove the correct calculation of a function without divulging its input values or executing the function again, it is provided according to the present invention to provide a verifiable cryptographic proof of the execution.

Against this background, a specific embodiment of the present invention implements a decentralized marketplace platform using MPC and so-called zero-knowledge proofs. The subscribers of the MPC calculation, which in some circumstances do not have any interest of their own in a correct result and could therefore send plausible random messages, prove the correctness of their calculation using such a cryptographic proof. An advantage of this solution in comparison with a centralized marketplace platform is that it avoids market failure due to monopolization.

Advantageous developments and improvements of the present invention are made possible by the measures described herein. Thus, in accordance with the present invention, it can be provided that the subscribers are rewarded with tokens within the system. The same tokens are used for payments to the trading subscribers within the marketplace system. In comparison with pure MPC approaches, such a realization offers an incentive for correct calculations, and therefore does not rely on the altruism of protocol subscribers who do not have a specific interest in the result.

According to a further aspect of the present invention, it is provided that the order data of the trade orders created on the platform be divided into a plurality of parts by a cryptographic secret sharing or secret splitting, which parts are in turn distributed among the MPC parties, so that these parties can further write the transaction database according to the protocol, independent of active participation in the actual trading platform. In this way, even for non-subscribers of the trading platform an incentive can be created to correctly follow the protocol.

According to a further aspect of the present invention, it can be provided that parties not taking part in the operation of the trading platform divide their inputs (trade orders) among the MPC parties. In this way, an active calculation in the MPC protocol is not necessarily required for participation in the marketplace.

### BRIEF DESCRIPTION OF THE DRAWINGS

Exemplary embodiments of the present invention are shown in the figures and are explained in more detail below.

FIG. 1 shows the flow diagram of a method according to a first specific embodiment.

FIG. 2 schematically shows a transaction system according to a second specific embodiment.

### DETAILED DESCRIPTION OF EXAMPLE EMBODIMENTS

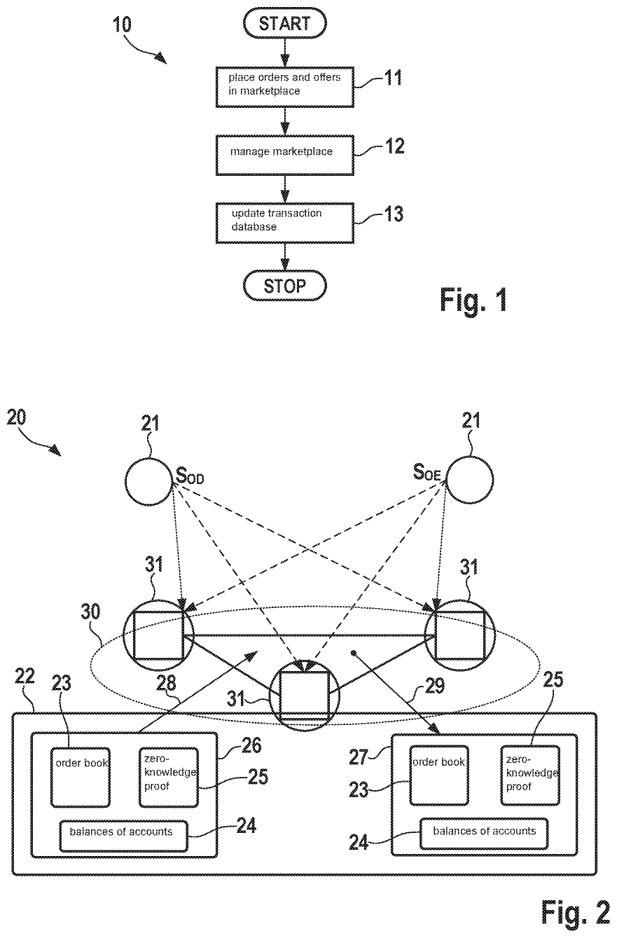

FIG. 1 shows the basic steps of an example method (10) according to the present invention for use in the transaction system shown in FIG. 2. The system is made up of subscribers (21) who wish to place orders and offers in the marketplace (process 11—FIG. 1), as well as parties (31)—traditionally referred to as players in the MPC expert literature—who follow a protocol for carrying out the marketplace transactions in the course of a multiparty calculation (30). These parties (31) may at the same time be subscribers (21) on the trading platform (20) itself, but may also be independent service providers or private persons. The subscribers (21) calculate parts (s_{OD}, s_{OF}) of their orders or offers, and distribute these to the MPC parties (31); for this, a standard method (10) is used, as described for example in BEIMEL, Amos, “Secret-sharing schemes: a survey,” in: International Conference on Coding and Cryptology, Springer, Berlin, Heidelberg, 2011, pp. 11-46.

The step named above is required only if the subscribers (21) of the trading platform (20) and the MPC parties (31) are not the same.

Using the obtained parts (s_{OD}, s_{OF}) and the last state (26) of a transaction database (22) that is managed for the marketplace (process 12—FIG. 1), in particular the so-called order book (23), the MPC parties (31) carry out the multiparty calculation (30), perform transactions in this way on the basis of the orders and offers, and calculate the new state (27). The precise type of carrying out of the transactions can be designed as a function of a centralized mechanism, with consideration of the desired properties of the marketplace and on the basis of social choice theory. Subsequently, this function can be implemented using a conventional framework, for example according to DAMGÅRD, Ivan, et al., “Practical covertly secure MPC for dishonest majority—or: breaking the SPDZ limits,” in: European Symposium on Research in Computer Security, Springer, Berlin, Heidelberg, 2013, pp. 1-18.

Optionally, together with each protocol message the zero-knowledge proof (25) of its correctness can be published. After following the protocol, each party receives a reward in the form of tokens for each correct proof (25).

The new balances of the accounts (24), as well as the new state (27) of the marketplace, are stored in the transaction database (22), which is expanded and updated with each multiparty calculation (30) (process 13—FIG. 1). These accounts share the reference currency of the orders and offers, so that an account can be assigned to each subscriber (21).

Inherent properties of the multiparty calculation (30) include that the system continues to exist as long as 50% of the MPC parties (31) are “honest,” and that these parties (31) do not by following the protocol obtain any information, beyond the provided reward, that they would be able to exploit to their own advantage. Thus, the MPC parties (31) are rewarded for their correct (and only for their correct) participation in the multiparty calculation (30).

For the processing of orders and offers, a fee model is possible, applied in addition to or instead of the incentive system of the MPC parties (31).

This method (10) can be implemented for example in software or in hardware, or in a mixed form of software and hardware.

What is claimed is:

1. A method for trading on an electronic trading platform, comprising the following steps:
providing trade orders of subscribers of the trading platform;
managing a decentralized transaction database of the trading platform, the transaction database including an order book, balances of accounts of the subscribers, and a zero-knowledge proof of a present state of the transaction database; and
based on the trade orders of the subscribers, starting from a current state, bringing the transaction database into a new state by a multiparty calculation.

2. The method as recited in claim 1, further comprising the following steps:
dividing order data of each of the trade orders into a plurality of parts by a cryptographic secret sharing;
distributed the parts are distributed among parties of the multiparty calculation;
reading the current state by the parties; and
writing the new state by the parties.

3. The method as recited in claim 1, wherein the subscribers include buyers and sellers.

4. The method as recited in claim 2, wherein a reward is paid to the parties for the multiparty calculation.

5. The method as recited in claim 4, wherein the reward is paid in a reference currency of the accounts.

6. The method as recited in claim 5, wherein the reference currency is a cryptocurrency.

7. The method as recited in claim 2, wherein the parties of the multiparty calculation are the subscribers of the trading platform.

8. A non-transitory machine-readable storage medium on which is stored a computer program for trading on an electronic trading platform, the computer program, when executed by a computer, causing the computer to perform the following steps:
providing trade orders of subscribers of the trading platform;
managing a decentralized transaction database of the trading platform, the transaction database including an order book, balances of accounts of the subscribers, and a zero-knowledge proof of a present state of the transaction database; and
based on the trade orders of the subscribers, starting from a current state, bringing the transaction database into a new state by a multiparty calculation.

9. A device for trading on an electronic trading platform, the device configured to:
provide trade orders of subscribers of the trading platform;
manage a decentralized transaction database of the trading platform, the transaction database including an order book, balances of accounts of the subscribers, and a zero-knowledge proof of a present state of the transaction database; and
based on the trade orders of the subscribers, starting from a current state, bring the transaction database into a new state by a multiparty calculation.
